(19) United States
(12) Patent Application Publication
(10) Pub. No.: US 2018/0210766 A1
(43) Pub. Date: Jul. 26, 2018

(54) MIGRATION FOR CLOUD MANAGEMENT SYSTEMS

(71) Applicant: HEWLETT PACKARD ENTERPRISE DEVELOPMENT LP, Houston, TX (US)

(72) Inventors: Yehia Beyh, Groton, MA (US); Mingyan Bao, Ft. Collins, CO (US); Weiwen Chen, Ft. Collins, CO (US)

(21) Appl. No.: 15/746,822

(22) PCT Filed: Jul. 23, 2015
(86) PCT No.: PCT/US2015/041814

§ 371 Date: Jan. 23, 2018

(51) Int. Cl. G06F 9/50; H04L 12/24; G06F 3/06

(52) U.S. Cl. CPC G06F 9/5083; H04L 41/0886; G06F 3/0647; G06F 9/5077; H04L 41/0896

(57) ABSTRACT

A method includes uploading a schema that describes links to cloud computing resources of a first cloud management system. The schema defines network connections and control of the cloud computing resources. The method includes importing the schema from the first cloud management system to a second cloud management system. The method includes switching the network connections and control of the cloud computing resources from the first cloud management system to the second cloud management system based on validation of the second cloud management system's communication links with the cloud computing resources identified by the schema.

### BACKGROUND

One type of cloud management system is referred to as OpenStack which is an open source cloud computing platform for all types of clouds. The OpenStack framework provides an Infrastructure-as-a-Service (IaaS) solution through a set of interrelated services. Each service offers an application programming interface (API) that facilitates this integration. Depending on particular needs, some or all of the services can be installed. Some examples of services include computing node services to manage a virtual machine, network services to communicate within a data center and externally to support data center workloads, and storage services to facilitate storage of data. One aspect of OpenStack referred to as Live Migration allows movement and control of resources within a single operating environment supported by an existing version of OpenStack. For example, one virtual machine may be able to have its control shifted from one host to another under an existing OpenStack cloud management system.

### BRIEF DESCRIPTION OF THE DRAWINGS

FIG. 1 illustrates an example of a system to migrate data center workloads from control of a first cloud management system to a second cloud management system.

FIG. 2 illustrates an example of a system implementation to operate a data center for a cloud and to migrate data center workloads from control of a first cloud management system to a second cloud management system.

FIG. 3 illustrates an example of a method to migrate data center workloads from control of a first cloud management system to a second cloud management system.

FIGS. 4 and 5 collectively illustrate example methods for downloading data from a first cloud management system.

FIGS. 6 and 7 collectively illustrate example methods for importing data to a second cloud management system and switching control to the second cloud management system.

FIG. 8 illustrates an example of a computer readable medium to migrate data center workloads from control of a first cloud management system to a second cloud management system.

### DETAILED DESCRIPTION

This disclosure relates to migration of data center workloads from control of a first cloud management system to a second cloud management system, which may have different capabilities and functions than the first management system. In existing cloud management systems, including OpenStack systems, data center resources can be moved within an existing data center such as between one virtual machine host to another within the same environment (e.g., referred to as Live Migration). There are no solutions however to migrate to a new cloud management system without shutting down the operating data center that is operating and under control of a previous cloud management system, such as OpenStack. A migration manager is provided to first determine what links exist to existing data center resources, such including as compute nodes, memory resources, and network resources and that are under control of the previous cloud management system. The migration manager then transfers the links to the respective resources to the new cloud management system. After verifying that the links can be controlled by the new management system, control is switched to the new cloud management system. Systems and methods disclosed herein thus enable migration to a new cloud management system without shutting down the currently operating data center that is under control of the previous cloud management system.

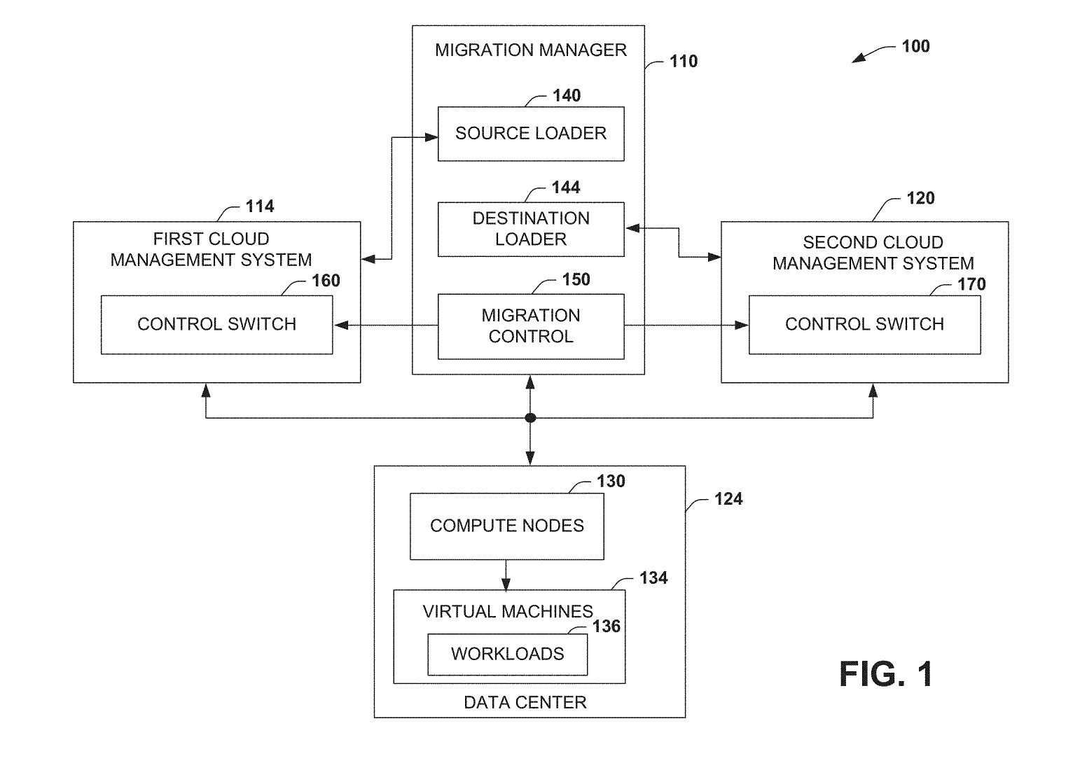

FIG. 1 illustrates an example of a system 100 to migrate data center workloads from control of a first cloud management system 114 to a second cloud management system 120. The second cloud management system can have different capabilities and functions than the first management system 114. As used herein, “cloud computing,” “computing cloud” and variants thereof refer to any of a variety of computing applications that can be accessed, implemented, or consumed on or across a cloud computing environment, such as the system 100. For example, the cloud computing system 100 can include storage resources (e.g., an arrangement of machine readable and writable media), computing resources (e.g., processors with one or more cores), and network resources (e.g., interconnects, switches and routers) and other capabilities such as platform services and applications. The system 100 can be hosted on a network, such as a public network (e.g., the Internet), a private network, a managed network environment, or a combination of different network types. Moreover, in the examples disclosed herein, memory resources, network resources, storage resources, and processing resources could be stored/operated on a single machine (e.g., a computer) or distributed across multiple machines (e.g., via a network).

The system 100 includes a migration manager 110 to migrate control from the first cloud management system 114 to the second cloud management system 120 to operate a data center 124. The first cloud management system 114 can be an existing version such as an OpenStack framework, for example. The second cloud management system 120 offers a new set of features and functions which operate differently from the first cloud management system 114. For instance, the second cloud management system 120 can be an upgraded management system designed to enhance or expand the capabilities of the first, existing cloud management system 114. The second cloud management system 120 could be a Helion-based framework or wrapper for example that provides additional features, functions, management, and processing capabilities from that of the first cloud management system 114.

The data center 124 includes computing resources to operate a cloud computing environment. The computing resources can include a network resource (e.g., network module and addresses to internal and external network links), a memory resource (e.g., database and server), and a compute node 130, where the compute node operates a virtual machine 136 (or machines) that services a workload 136 (or workloads) in the cloud computing environment. The compute node 130 can operate as a hypervisor that operates one or more virtual machines 134. The workloads 136 can be substantially any type of service including memory storage services, website servers, e-mail servers, and so forth.

In one example, the data center 124 supports a private cloud operating one or more workloads 136 where the migration manager 110 transfers control of the private cloud from the first cloud management system 114 to the second cloud management system 120. In another example, the data center 124 represents higher level functionality such as an enterprise service that can support multiple private clouds servicing one or more tenants and/or a combination or public and private clouds. In some cases, only base-level or private cloud services are migrated by the migration manager 110 and in other cases both base-level and enterprise services are migrated.

The migration manger 110 includes a source loader 140 to upload a schema that describes links to cloud computing resources of the first cloud management system 114. The schema defines network connections and control of the cloud computing resources. For example, the schema can include data defining internal and/or external IP address connections and links supported by the data center 124, database links to memory resources utilized by the data center, configuration information to operate the compute nodes 130, virtual machines 134, and/or workloads 136. The source loader 140 can operate in the migration manager or be installed on the first cloud management system 114, for example. A destination loader 144 in the migration manager 110 imports the schema from the first cloud management system 114 to the second cloud management system 120. Similarly, the destination loader 144 could alternatively be installed on and implemented as part of the second cloud management system 120.

A migration control 150 switches the network connections and control of the cloud computing resources in the data center 124 from the first cloud management system 114 to the second cloud management system 124 in response to validation of the second cloud management system's communication links with the cloud computing resources identified by the schema. This can include validating internal and/or external IP address connections and links supported by the data center 124, database links to memory resources utilized by the data center, configuration information to operate the compute nodes 130, virtual machines 134, and/or workloads 136. As shown, a control switch 160 switches off connections in the first cloud management system 114 and a control switch 170 switches connections of the data center resources to the second cloud management system's control.

There can be hundreds of thousands of connections to determine and switchover during migration between cloud management systems. Given the number of connections, it would be impracticable (if not impossible) for manual discovery of such connections (e.g., without error and without shutting down the data center) and could exceed a user's lifetime if an attempt were made at manual rerouting of such connections. Thus, processor-automated transfer and validation of connections is provided facilitate automatic transfer of control between cloud management systems without shutting down existing data center 124 operations. For example, before during, and after migration between cloud management systems, the compute nodes 130, the virtual machines 134, and workloads can remain in operation servicing user needs while the migration occurs.

The migration manager 110 executes automated procedures to migrate control of the data center from the first cloud management system 114 to the second cloud management system 120. Such automated procedures can include a plurality of automated loading, importing, and validation processes. For example, the automated processes can include migrating the data center 124 from being managed by the first cloud management system 114 running an older version of software to the second cloud management system 120 running a newer, updated version of the software. As mentioned the second cloud management system 120can provide features and functionality not provided by the older version.

The automated procedures can include uploading migration tools (e.g., source loader) to the first cloud management system 114, for example. A validation can be performed to determine the first management system 114 is operating normally (e.g., within expected operating parameters) such that no catastrophic errors during service of the workloads 136 are detected. After initial validation, the processes employ the source loader 140 to download data from the first cloud management system 114 to the migration manager 110. The data can include database contents, configuration files for services (e.g., OpenStack services) and cloud automation services. The data can further include access information such as user credentials, for example. This can include network configuration information for how the management system itself is setup, and how the management system is connected to the resources it's managing, e.g., compute resources, storage resources, and so forth. After uploading, the migration manager 110 validates the second cloud management system 120 is operating normally and is ready to accept the management of the data center resources. Again, this can be a check of status that no errors have occurred. After validation, the destination loader 144 imports the data received during the upload procedure from the first system 114 to the second system 120.

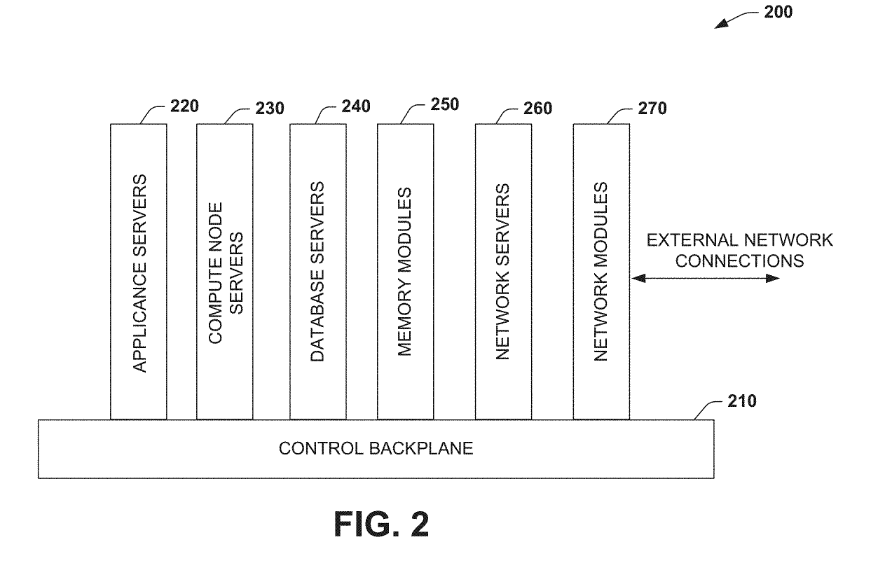

As mentioned previously, the imported data can include database contents, service configuration data, users and their credentials, for example. After importing, the migration manager 110 reconfigures networking on the second system 120 to correlate with the first system 114. This can include utilizing pre-existing subnets established by the first system 114 and/or creating new subnets with the second system 120. This can further include reconfiguring control plane networking (See e.g., FIG. 2) and reconfiguring networking for compute nodes 130. After reconfiguration, the second cloud management system is validated that it is operating normally including checking error status and providing feedback such that it can be confirmed that the same amount of memory resources are controlled, the same amount of processing power is provided, the same amount of internal or external network connections are supported, and the same amount of data center recourses including compute nodes, virtual machines, and workloads are supported. Automated procedures can also include removing obsolete data and objects on the data center 124 that are no longer in use by the second cloud management system 120 after migration.

FIG. 2 illustrates an example of a system 200 configured to operate a data center for a cloud. The system 200 further is configured to migrate data center workloads from control of a first cloud management system to a second cloud management system having different capabilities and functions than the first management system. In this example, the system, such as illustrated and described above with respect to cloud management systems 114, 124, and data center 120, can be implemented on a control backplane 210 where cloud management systems and data center resources can be provided. As shown, the control backplane 210 can include one or more appliance servers 220. The appliance servers 220 can operate the cloud management systems described herein. For example, one appliance server 220 could operate the first cloud management system and a second appliance server could be installed on the control backplane 210.

The control backplane 210 can also include one or more compute node servers 230 along with one or more database servers 240 which can communicate with one or more memory modules 250 across the control backplane. The control backplane 210 can also communicate with one or more network servers 260 which can communicate with one or more network modules 270 to provide external network connections. In addition to the external network connections, the control backplane 210 can also provide internal network connections between modules on the backplane. The compute node servers 230, database servers 240, memory modules 250, network servers 260, and network modules 270, can collectively support the data center functionality and resources described herein. Although shown as a backplane configuration in this example, each of the modules could operate independently of the control backplane where the independent modules communicated over external network connections rather than the control backplane 210 illustrated in this example.

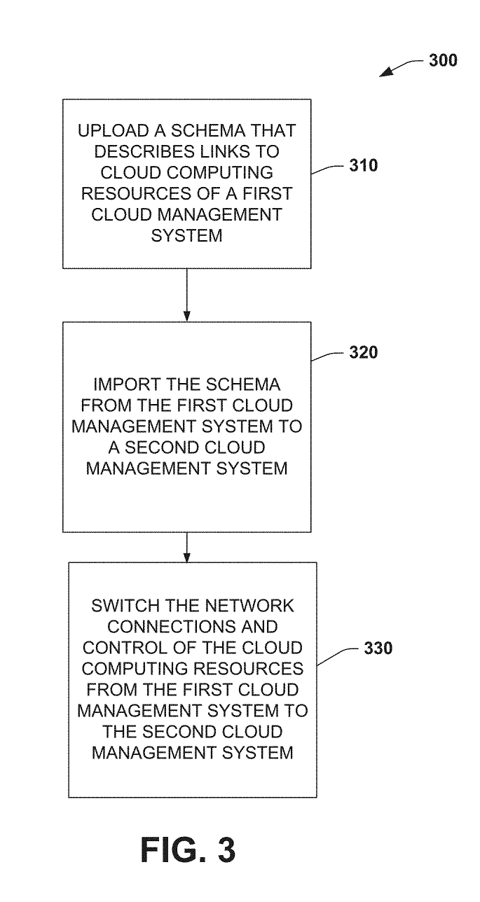

In view of the foregoing structural and functional features described above, example methods will be better appreciated with reference to FIGS. 3 though 7. While, for purposes of simplicity of explanation, the methods are shown and described as executing serially, it is to be understood and appreciated that the methods are not limited by the illustrated order, as parts of the methods could occur in different orders and/or concurrently from that shown and described herein. Such methods can be executed by various components and executed by an integrated circuit, computer, or a processor, for example.

FIG. 3 illustrates an example of a method 300 to migrate data center workloads from control of a first cloud management system to a second cloud management system, which as disclosed herein, can have different capabilities and functions than the first management system. At 310, the method 300 includes uploading a schema that describes links to cloud computing resources of a first cloud management system, the schema relating to network connections and control of the cloud computing resources (e.g., via source loader 114 of FIG. 1). At 320, the method 300 includes importing the schema from the first cloud management system to a second cloud management system (e.g., via destination loader 144 of FIG. 1). At 330, the method 300 includes switching (e.g., via migration control 150 and control switches 160 and 170 of FIG. 1) the network connections and control of the cloud computing resources from the first cloud management system to the second cloud management system based on validation of the second cloud management system's communication links with the cloud computing resources identified by the schema.

Although not shown, the method 300 also can include operating the cloud computing resources in a data center that includes a network resource, a memory resource, and a computing node, the computing node operating a virtual machine that services a workload in a cloud computing environment. The can include validating that the first cloud management system is operating under normal conditions by verifying error status of the first cloud management system before uploading the schema. The method 300 can also include uploading the schema that includes uploading database contents from database servers, uploading configuration files for the first cloud management system, uploading user credentials, and uploading network configuration information. The method 300 can also include validating that the second cloud management system is operating under normal conditions by verifying error status of the second cloud management system before importing the schema.

The method 300 can include reconfiguring network connections of the second cloud management system to correlate with the network connections of the first cloud management system such that the links to the cloud computing resources are accessible by the second cloud management system (e.g., via migration control 150 of FIG. 1). This can include reconfiguring network connections for compute nodes from the first cloud management system to the second cloud management system and reconfiguring control plane connections from the first cloud management system to the second cloud management system based upon the links in the imported schema. The method 300 can also include validating that the second cloud management system provides a comparable level of service by analyzing memory capabilities, processing capacity, and validity of network paths are in accordance with system status levels of the first cloud management system before switching control to the second cloud management system (e.g., via migration manager 110 of FIG. 1). This can include switching control of an enterprise service from the first cloud management system to the second cloud management system, where the enterprise service can manage multiple private clouds or a combination of public and private clouds.

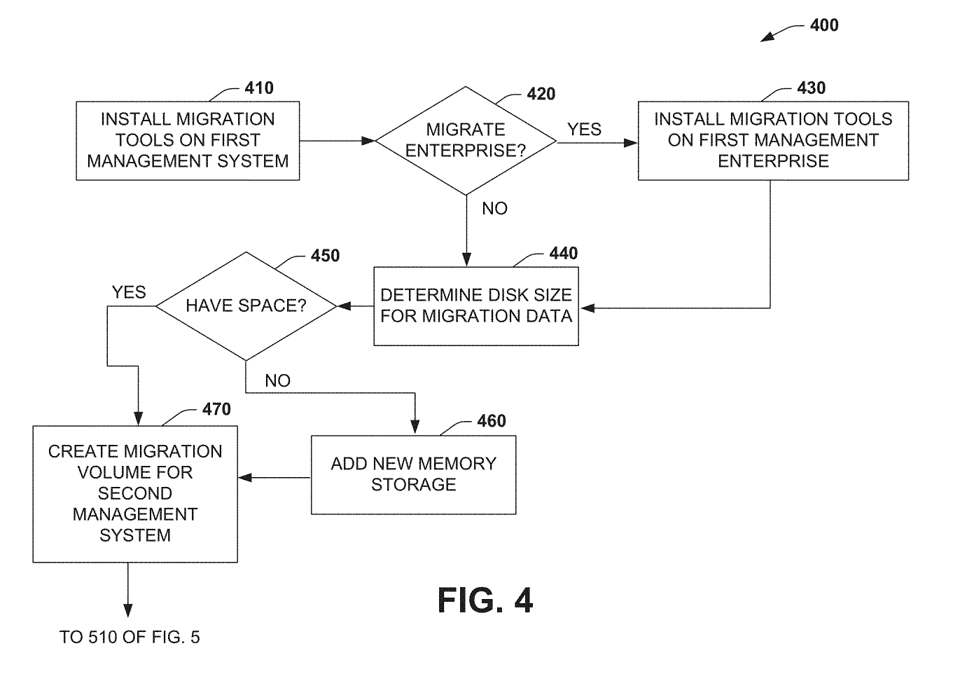

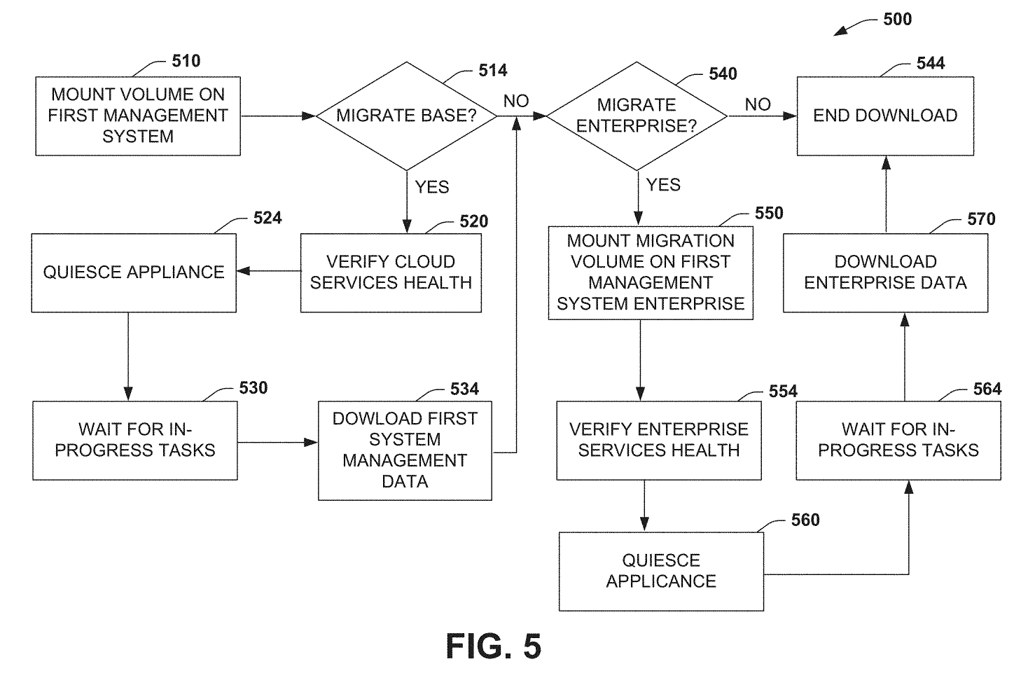

FIGS. 4 and 5 collectively illustrate example methods 400 and 500 for downloading data from a first cloud management system. At 410, the method 400 includes installing migration tools on a first cloud management system (e.g., source loader 140). At 420, the method 400 includes determining whether an enterprise service is to be migrated. If yes, the method 400 proceeds to 430 and installs migration tools on a first management enterprise (e.g., server operating enterprise services). If no enterprise migration is determined at 420, or enterprise tools have been installed at 430, the method 400 proceeds to 440 and determines a disk size for migration data (e.g., determine size of disk to hold schema information via migration manager 110 of FIG. 1). At 450, a determination is made as to whether or not enough disk space is available. If no, the method 400 proceeds to 460 and adds new memory storage capabilities to support the migration. If yes at 450, the method proceeds to 470 to create a migration volume (e.g., allocate memory space for migration via migration manager 110 of FIG. 1) for a second cloud management system. After 470, the method proceeds to 510 of FIG. 5 to continue with the download process.

At 510 of the method 500, a disk volume is mounted for the first cloud management system (via migration manager 110 of FIG. 1). At 514, a determination is made as to whether or not to migrate base level services only (e.g., private cloud services only via migration manager 110 of FIG. 1). If yes, the method 500 proceeds to 520 and verifies cloud services health by observing if any errors are present. At 524, the method 500 includes placing appliances in a quiescent state such that now new services are initiated during the migration. As used herein, the term quiescent refers to checking that no new services are being added to the first cloud management system before proceeding (e.g., via migration manager 110 of FIG. 1). At 530, the method 500 waits for in-progress tasks to complete on the first cloud management system. After in-progress tasks have completed at 530, the method 500 downloads first cloud system management data at 534 (e.g., via schemas describing data, network connections, and configurations).

After the download at 534, the method proceeds to 540 to determine if enterprise migrations are involved. If no, the method 500 proceeds to 544 and ends the automated download procedure. If yes at 540, the method proceeds to 550 and mounts a migrations volume for the enterprise. At 554, the method verifies enterprise services health (e.g., checking error status via migration manager 110 of FIG. 1). At 560, the method waits until the appliance for the enterprise server is in a quiescent state. At 564, the method waits for enterprise in-progress tasks. At 570, enterprise data is downloaded from the first enterprise system. After enterprise downloading at 570, the download ends at 544.

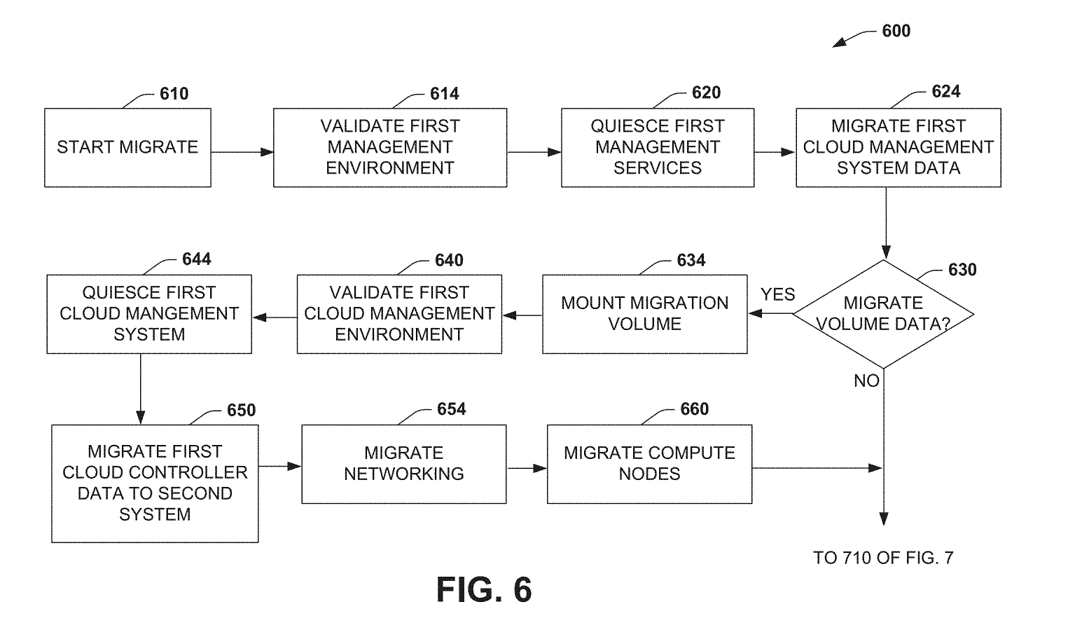

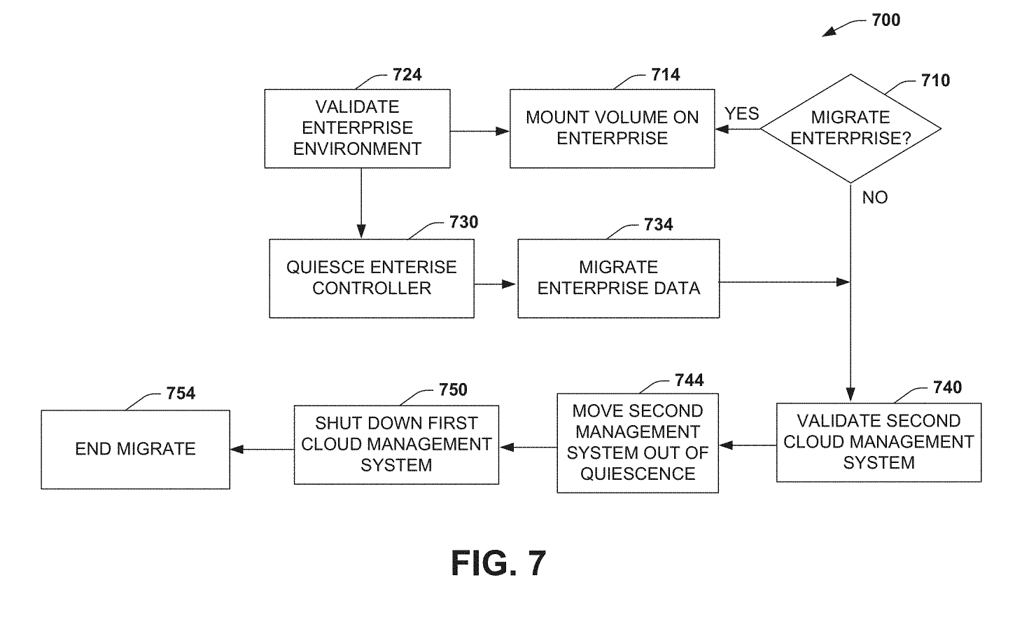

FIGS. 6 and 7 collectively illustrate example methods 600 and 700 for importing data to a second cloud management system and switching control to the second cloud management system. At 600 of the method 600, a migration process is started. At 614, the method includes validating a first management system environment which can include checking status for controller errors before proceeding. At 620, the method waits until management service updates are stable and pending services are no longer requested. At 624, the method migrates first cloud management system data to the second cloud management system. At 630, a determination is made whether to migrate volume data from the first management system to the second system. If yes, at 630, the method proceeds to 634 and mounts a migration volume for the migration. At 640, the method validates the first management system environment by checking for status errors before proceeding. At 644, the method waits until cloud controller services are in a quiescent state. At 650, cloud data is migrated from the first management system to the second management system. At 654, networking and other connections are migrated. At 660, compute nodes are migrated (e.g., network connections and database paths to operate compute nodes). After 660 of if the determination at 630 was no, the method proceeds to 710 of FIG. 7.

At 710 of the method 700, the method determines if enterprise migration is determined. If no, the method proceeds to 744. If yes at 710, the method proceeds to 714 and mounts a volume on the enterprise. At 724, the enterprise environment is validated by checking error status in the environment. At 730, the method waits until the enterprise controller is in a quiescent state. At 734, the method migrates enterprise data to the second cloud enterprise system and validates the second enterprise system at 740 to confirm status. At 744, the method includes moving the second management system out of quiescence. At 750, the first cloud management system is shut down. At 754, the migration ends.

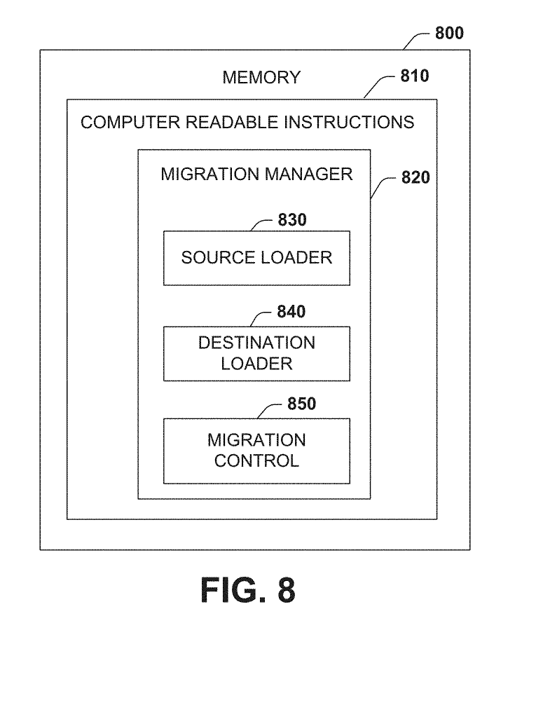

FIG. 8 illustrates an example of a computer readable medium 800 to migrate data center workloads from control of a first cloud management system to a second cloud management system having different capabilities and functions than the first management system. The computer readable can be a non-transitory medium such as a memory having computer readable instructions 810 stored thereon. The instructions 810 can be configured to support operations of a migration manager 820 as previously described. The instructions can be configured other functional blocks in the migration manager 820. These include a source loader 830 having instructions to upload a schema that describes links to the cloud computing resources from a first cloud management system. The schema relates to network connections and control of the cloud computing resources. A destination loader 840 is configured to import the schema from the first cloud management system to a second cloud management system.

A migration control 850 can be configured to switch the network connections and control of the cloud computing resources from the first cloud management system to the second cloud management system based on validation of the second cloud management system's communication links with the cloud computing resources identified by the schema. The instructions 810 can also include instructions to operate cloud computing resources that include a network resource, a memory resource, and a compute node, where the compute node operates a virtual machine that services a workload in a cloud computing environment.

What have been described above are examples. It is, of course, not possible to describe every conceivable combination of components or methods, but one of ordinary skill in the art will recognize that many further combinations and permutations are possible. Accordingly, the invention is intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. A method comprising:
uploading a schema that describes links to cloud computing resources of a first cloud management system, the schema defines network connections and control of the cloud computing resources;
importing the schema from the first cloud management system to a second cloud management system; and
switching the network connections and control of the cloud computing resources from the first cloud management system to the second cloud management system based on validation of the second cloud management system's communication links with the cloud computing resources identified by the schema.

2. The method of claim 1, further comprising operating the cloud computing resources in a data center that includes a network resource, a memory resource, and a compute node, the compute node operating a virtual machine that services a workload in a cloud computing environment.

3. The method of claim 1, further comprising validating that the first cloud management system is operating under normal conditions by verifying error status of the first cloud management system before uploading the schema.

4. The method of claim 1, wherein uploading the schema includes uploading database contents from database servers, uploading configuration files for the first cloud management system, uploading user credentials, and uploading network configuration information.

5. The method of claim 4, further comprising validating that the second cloud management system is operating under normal conditions by verifying error status of the second cloud management system before importing the schema.

6. The method of claim 1, further comprising reconfiguring network connections of the second cloud management system to correspond to the network connections of the first cloud management system such that the links to the cloud computing resources are accessible by the second cloud management system.

7. The method of claim 6, further comprising reconfiguring network connections for compute nodes from the first cloud management system to the second cloud management system and reconfiguring control plane connections from the first cloud management system to the second cloud management system based upon the links in the imported schema.

8. The method of claim 7, further comprising validating that the second cloud management system provides a comparable level of service by analyzing memory capabilities, processing capacity, and validity of network paths are in accordance with system status levels of the first cloud management system before switching control to the second cloud management system.

9. The method of claim 1, further comprising switching control of an enterprise service from the first cloud management system to the second cloud management system, where the enterprise service can manage multiple private clouds or a combination of public and private clouds.

10. A system, comprising:
a processor to execute computer executable instructions from a memory; and
a migration manager configured from the computer executable instructions in the memory to migrate control from a first cloud management system to a second cloud management system to operate a data center, the migration manager computer executable instructions comprising:
a source loader to upload a schema that describes links to cloud computing resources of the first cloud management system, the schema defines network connections and control of the cloud computing resources;
a destination loader to import the schema from the first cloud management system to the second cloud management system; and
a migration control to switch the network connections and control of the cloud computing resources from the first cloud management system to the second cloud management system based on validation of the second cloud management system's communication links with the cloud computing resources identified by the schema.

11. The system of claim 10, further comprising a data center comprising the computing resources to operate a cloud computing environment, the computing resources include a network resource, a memory resource, and a compute node, the compute node operating a virtual machine that services a workload in the cloud computing environment.

12. The system of claim 10, wherein the migration control of the migration manager reconfigures network connections for compute nodes from the first cloud management system to the second cloud management system and reconfiguring control plane connections from the first cloud management system to the second cloud management system based upon the links in the imported schema.

13. The system of claim 12, wherein the migration manager validates that the second cloud management system provides a comparable level of service by analyzing memory capabilities, processing capacity, and validity of network paths are in accordance with system status levels of the first cloud management system before switching control to the second cloud management system.

14. A non-transitory computer readable medium having computer executable instructions stored thereon, the instructions configured to:
upload a schema that describes links to the cloud computing resources from a first cloud management system, the schema defines network connections and control of the cloud computing resources;
import the schema from the first cloud management system to a second cloud management system; and
switch the network connections and control of the cloud computing resources from the first cloud management system to the second cloud management system based on validation of the second cloud management system's communication links with the cloud computing resources identified by the schema.

15. The non-transitory computer readable medium of claim 14, further comprising instructions to operate cloud computing resources that include a network resource, a memory resource, and a compute node, the compute node operating a virtual machine that services a workload in a cloud computing environment.
